(19) United States
(12) Patent Application Publication
(10) Pub. No.: US 2009/0132341 A1
(43) Pub. Date: May 21, 2009

(54) Method and System for Monetizing User-Generated Content

(76) Inventors: Theresa Klinger, Alamo, CA (US); Ariel Wada, Larkspur, CA (US)

Correspondence Address: Brian R. Galvin, P.O. BOX 2360, SILVERDALE, WA, 98383-2360, US

(21) Appl. No.: 11/968,374

(22) Filed: Jan. 2, 2008

Related U.S. Application Data
(60) Provisional application No. 60/989,425, filed on Nov. 20, 2007.
(60) Provisional application No. 61/013,548, filed on Dec. 13, 2007.

(51) Int. Cl. G06Q 30/00

(52) U.S. Cl. 705/10

(57) ABSTRACT

An e-commerce system, comprising a shopping cart executing on a network-connected server, product information available at the shopping cart, and software executing on the server for interacting with user-generated content associated with a first user, is disclosed. In the system, the software provides product information and code related to a specific product to the user-generated content in a form compatible with the user-generated content, such that upon the code being activated in the user-generated content by a second user, the second user is connected to the shopping cart at the server, and enabled to buy the product.

### CROSS-REFERENCE TO RELATED APPLICATIONS

The present application claims priority to Provisional Application Ser. 60/989,425, filed Nov. 20, 2007 and Provisional Application Ser. 61/013,548, filed Nov. 20, 2007. The disclosures of which are included herein at least by reference.

### BACKGROUND OF THE INVENTION

1. Field of the Invention

The present invention is in the field of e-commerce, and particularly as it pertains to virtual communities such as social networks, online gaming communities and “virtual worlds”. Yet more particularly, the present invention pertains to monetization of user-generated content on networks such as the Internet.

2. Discussion of the State of the Art

In the field of entertainment media, several trends have emerged in recent years, quite separately, that when combined offer surprising new possibilities for individuals and enterprises alike. One of these trends is emergence of product placements as a new kind of advertisement. This now familiar technique involves the advertiser (a vendor of products such as personal computers, cars, liquors and toys, just to name a few) paying content creators (movie studios, TV studios and others) to display or refer to their products in prominent ways within the content itself. This is in stark contrast to previous practices in advertising, where the boundary between advertising and entertainment content was clearly defined; with product placements, commercial messages can be included within content for which consumers pay to view, and with which consumers are strongly emotionally engaged.

A second trend is democratization of content creation. In the age of the great movie studios, control of content creation (at least in the new media of radio and the movies) was entirely within the hands of a few very powerful businessmen. Later, as the costs of high quality production came down, and as more and more channels to market became available, first through UHF television stations and later through cable and satellite systems, content creation became more diffuse, taking place across thousands of companies acting in various capacities. But only recently has serious content routinely been created by individuals, by consumers. The emergence of “user-generated content” (UGC) has been a large part of the post-2000 boom in user-centric web services, which commonly is labeled broadly as Web 2.0. Today, with blogs, personal web pages, and sites for the uploading of user-generated music and video clips, more and more of what people read, hear and watch is created outside of the corporate world, in the world of UGC.

Another important trend has been emergence of highly targeted advertising. Advertising once was a mass media affair, and segmentation tended to go no further than choosing during which radio or television show to advertise. Today, Internet portal companies, search engines, marketing database companies with access to credit card and other financial data all compete to precisely target advertisements to ever more finely sliced segments of the consumer population. The rapid rise of Google has also shown how much the advertising equation has changed; while charging only a tiny fraction of what traditional media charged for advertising, and while permitting only the most rudimentary text-based advertisements, Google has grabbed a significant share and built a highly profitable business because its ad placements are highly targeted and because advertisers only pay when ads are clicked.

Finally, the last few years have seen emergence of another new category of web-based entity, the social network. Already there are thousands of these, ranging from the very large operators such as MySpace or Facebook to very small, highly verticalized players. There is even a company selling a platform for launching new social networks. And social networking has quickly become one of the major outlets for user-generated content (in fact, one can view each subscriber's profile page as a form of UGC).

As is typical in web trends, the original social networking pioneers offered “something for nothing”, and most social networking sites continue to offer a wide range of free services. But soon after, people began seeking ways to develop profitable business models to monetize the large numbers of loyal users that had been created in a very short time. Much as Google did in search, these pioneers are looking to advertising to satisfy the need to generate revenue from highly visited social networking sites, and they are typically adopting the methods used by Google—allowing users to provide access to advertisers on their profile pages in return for a small slice of the advertising revenue. This is by now a classical business model—the site operator, the user whose profile page is used, the media buyer and others each take a piece of the total advertising spend committed by the advertisers (these by and large are the same kinds of companies as in all of the previous ages, plus the new web-based companies).

Beyond social networks, other forms of virtual communities have become commonplace in the art. Among these are online gaming communities in which large numbers of individuals cooperate and compete in network-hosted gaming systems. Many of these are typified by games that are indefinite in nature, and it is common for complex social structures similar to social networks to arise intentionally or merely as a result of actions taken by many people in pursuit of their goals. Many online gaming communities include a strong element of user-generated content, with similar challenges and opportunities for monetization of this content. Other forms of virtual communities typified by widespread adoption and propagation of user-generated content, and the concomitant need for means to monetize that content, include “virtual worlds” and file sharing communities. All of these are merely exemplary of a strong shift away from static content to user-generated content in the online world, and these examples should not be considered to be limiting for the purposes of the present invention. All virtual communities in which user-generated content plays a prominent role provide background for, and will benefit from, the present invention.

One limitation of the currently emerging model of allowing advertisers to place ads on profile pages is that it is a largely passive affair. A user can, for instance, subscribe to one of the many affiliate advertising services and make a space available for ads to be displayed, but the user has no control over what ads are displayed. Advertisers will display ads that seem to correlate well with the content of the page (for instance, a user's blog on “the new physics” will likely show ads from a science magazine, whereas one that focuses on a particular sports team would likely show ads promoting sports apparel or memorabilia. But the user cannot choose, and certainly the user cannot block undesirable advertisers from her page.

This limitation, besides providing for the possibility of incongruous and occasionally counterproductive ad placements, also leads to an inability of mainstream advertisers to take advantage of the most powerful aspect of social networks—which is precisely that social networks are self-organized market segments. People who network together, whether in a broad “network of friends” sense or in a narrow “network of first edition enthusiasts” sense, automatically define segments of great interest to advertisers, as these social networks generally will share much in common, including buying habits. But since the essence of social networks is their self-organization and, accordingly, their dynamic nature, the traditional advertising model falls short.

What is clearly needed in the art is a way to bring together the worlds of advertising and social networks in a way that serves the best interests of both key constituents—those who wish to advertise and those to whom advertisers are directed. Users of social networks, should they be able to influence what, when and how is advertised to them, would be able to achieve the reasonable goal of having ads that address actual needs and preferences, and to share in the benefits thus created. And, in a continuation of the trend away from mass advertising that the search-based ad illustrates, advertisers would be able to precisely target content at those social networks that are most predisposed to favorably react to the message, and to do so at a remarkably low cost, thus driving revenue per ad dollar up dramatically.

It is an aim of the present invention to provide a system and a method for monetizing the user-generated content that dominates social networks sites, and to provide advertisers a method to “ride the user-generated content” wave in order to achieve improved levels of targeting specificity and return on investment.

### SUMMARY OF THE INVENTION

In an effort to solve the problems described above of monetizing user-generated content, the inventors conceived of a fundamental shift in the longstanding paradigm of advertising. Specifically, they conceived of the notion of shifting from the model of vendors hawking their own wares through various advertising means involving the pushing of vendor materials to potential consumers to the model of users promoting and selling products that they personally find valuable or useful. Accordingly, the inventors provide a system for the monetization of user-generated content using user-controlled product placements within user-generated content.

More particularly, in a preferred embodiment of the invention an e-commerce system is disclosed that is comprised of a shopping cart executing on a network-connected server, product information available at the shopping cart, and software executing on the server for interacting with user-generated content associated with a first use. In this embodiment, the software provides product information and code related to a specific product to the user-generated content. The code is compatible with the user-generated content, and upon the code's being activated in the user-generated content by a second user who is accessing that content, the second user is connected to the shopping cart at the server and is thus enabled to buy the product while still connected to the user-generated content.

In preferred embodiments, the shopping cart executes on a social networking server, an online gaming server, or an online virtual world server. These embodiments are exemplary; the shopping cart of the invention can execute within any server that is adapted to host user-generated content without limiting the generality of the invention. In further preferred embodiments, the user-generated content is accessed from web browsers, Internet-connected mobile communications devices, computing devices, or gaming consoles. These embodiments are exemplar; the user-generated content can be accessed from any suitable electronic device or software application suitably adapted to the particular form of user-generated content without limiting the generality of the invention.

In a preferred embodiment, the product information provided by the shopping cart for embedding in user-generated content pertains to products from a plurality of distinct selling entities.

In yet another embodiment of the invention, the shopping cart calculates all costs associated with the purchasing the product within the user-generated content and provides an updated total to the second user to facilitate purchase. In a further embodiment, these costs include a fee to be paid to the first user when a specific interaction with the second user occurs.

In another preferred embodiment of the invention, the shopping cart provides information about a plurality of products available for sale by the first user when requested by that user and, upon selection by that user of a particular product to promote, provides to the first user code and product information suitable for embedding in the user-generated content.

In another preferred embodiment of the invention, the shopping cart provides valuable reputation statistics to end users who view product placements within user-generated content by collecting feedback from viewing users and aggregating that feedback with further feedback from a plurality of other users and using the statistics resulting from this aggregation to provide statistics on the quality of product placements included within user-generated content. In a further embodiment, this feedback is used to modify the fee paid to the users who place product information within their user-generated content. In general, users with higher quality feedback would be eligible to receive higher fees for executing product placements, as these placements are more likely to yield revenue for the operator of the shopping cart and for the vendors of the promoted products.

### BRIEF DESCRIPTION OF THE DRAWING FIGURES

FIG. 1 is a block diagram of components of the invention in one embodiment, highlighting different roles played in carrying out the invention.

FIG. 2 is a process flow diagram of a method of the present invention.

FIG. 3 is an example of a user-generated content page illustrating one way users can consume monetized user-generated content according to the present invention.

FIG. 4 is an example of a mobile phone based instance of the present invention.

FIG. 5 is another example of use of the present invention, as a means for monetizing user-generated content in a multiplayer online gaming environment.

FIG. 6 is a process flow diagram of a financial transaction conducted according to an embodiment of the present invention.

FIG. 7 is a process flow diagram of a product promotion quality rating process of an embodiment of the invention.

### DETAILED DESCRIPTION

The inventors provide a system and a method for monetization of “user-generated content” (UGC) in which creators of UGC are enabled to select from a variety of products, from a variety of vendors, and to make them available for viewing and purchase entirely within their UGC. That is, it is an object of the present invention that creators of UGC are able to choose product information about products of their choosing and to embed that information, in a variety of ways, into their content (“content” should be understood to mean “user-generated content (UGC)” unless otherwise specified throughout this specification). It is an object of this invention that viewers of UGC that has been prepared using the instant invention will be able to view the images or information associated with the products being promoted by the creator of the particular UGC, and to purchase such promoted products, or to mark them for potential future purchase, as desired. It is yet another object of this invention to provide a monetary reward to the creators of UGC who thus successfully promote products for sale; it should be understood, however, that rewards other than money may also be given to such creators of UGC according to the invention. For example, “loyalty points” such as frequent flyer miles could be rewarded as a proxy for monetary reward, without departing from the spirit of the invention. Where “monetization” and “money” are used in this specification, they should be understood to mean “monetization or the like” and “money or an equivalent reward”; the form of the reward provided is not an essential element of the invention.

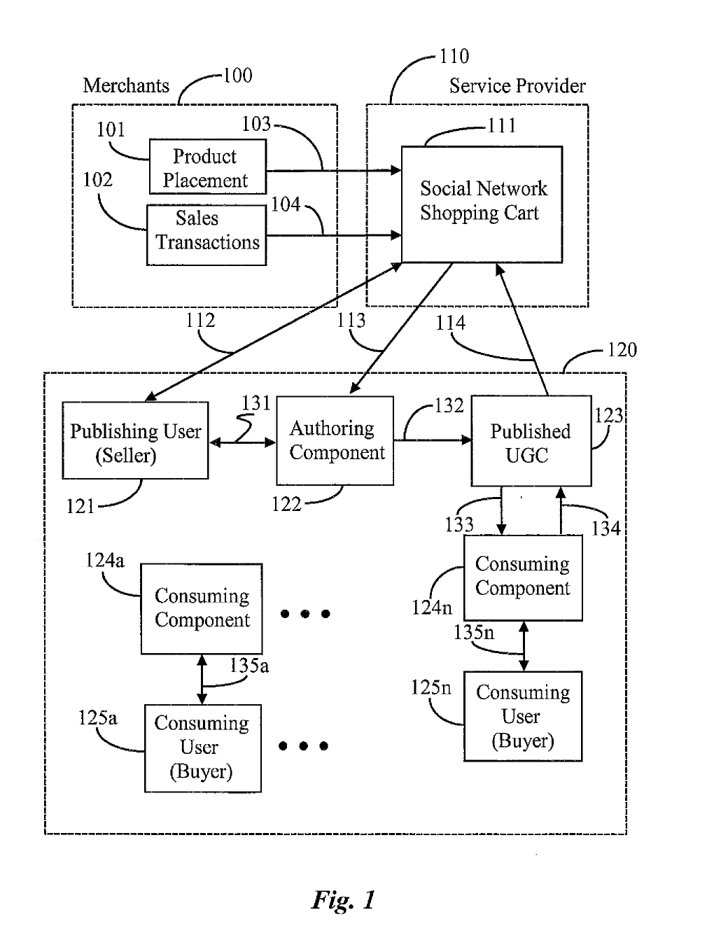

FIG. 1 is an illustration of an embodiment of the invention in which a social network 120 is enhanced by the provision of a social network shopping cart 111, which can be provided as a service by a service provider 110 such as a third-party web services provider. The social network shopping cart 111 alternatively can be provided by the social network 120 itself, without the need of a third-party service provider 110. The social network shopping cart 111 of the invention provides a means for merchants 100 to make product placements 101, passing product information about products that are available for sale through the social network 120 using interface 103 to the social network shopping cart 111, as well as a means for receiving sales transactions 102 from the social network shopping cart 111 via another interface 104. It should be noted that the interfaces 103 and 104 need not be separate, but the functions of product placement 101 and sales transactions 102 could be carried out over a single interface between the merchant's 100 systems and the social network shopping cart 111.

Social networks 120 are common on the Internet today, and typically provide their members (121 and 125a through 125n) with a variety of services intended to enable them to establish their own social groupings dynamically in a content-rich way. Among these services, social networks 120 typically provide some form of authoring component 122, where a publishing user 121 can create and edit content 131 and, when satisfied, make that content available as published UGC 123 to other users (125a through 125n) via consuming components (135a through 135n). Without loss of generality, it should be noted that in a preferred embodiment the authoring component 122 is a web page where publishing users may create and edit content 131 such as blogs, profile pages, photos, videos, personal web pages and the like. Also without loss of generality, it should be noted that in a preferred embodiment the consuming components (135a through 135n) are web browsers, and the published user-generated content 123 consists of pages within a social network's 120 web site that contain the UGC created by user 121 in authoring component 122.

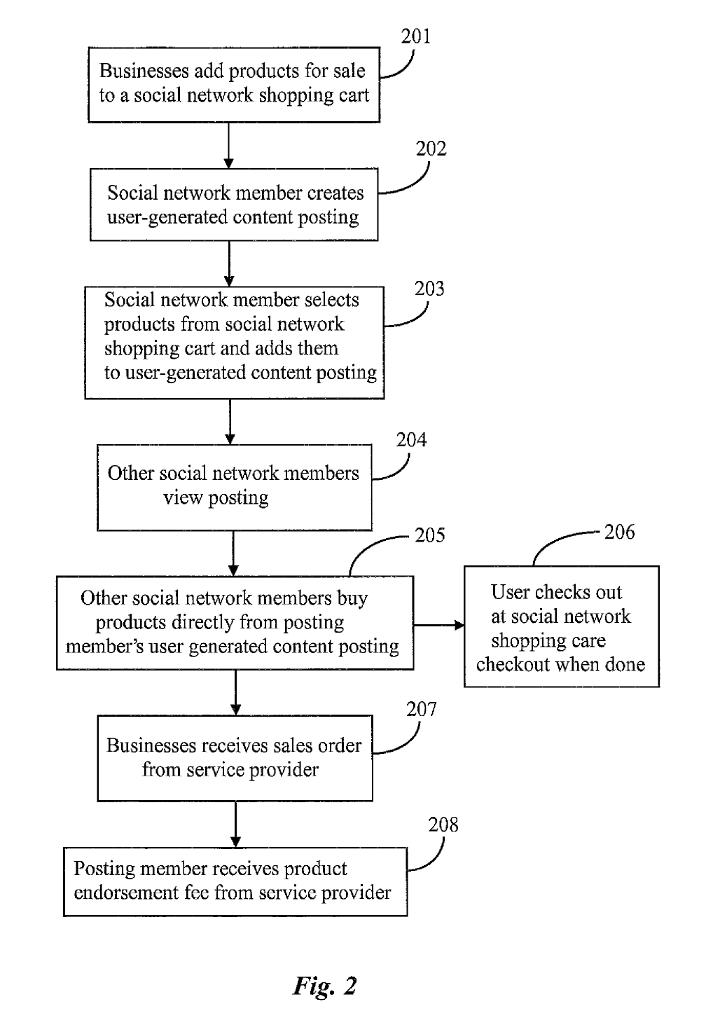

While in an embodiment the social network 120 is one of the many familiar social networks available on the Internet, it should be understood that the invention can be used to market goods and services to any human network 120, for example (but not limited to) console or online gaming systems where gamers create UGC and the gaming industry operates the social network shopping cart 110 of the invention, kiosks where UGC is delivered to malls or stores using the method of the invention (the social network shopping cart 110 in this case could be operated by an operator of a chain of malls, or a chain of stores, or by a specialist third party who places kiosks in prominent places to allow consumption of UGC by social network members), virtual worlds where groups or entire virtual societies are formed and the social network shopping cart 110 is operated either by the host of the virtual world or by a third-party service provider, or even offline networks such as groups of “friends and family” who subscribe to a value-added mobile phone service that allows users to create and post content that can be viewed on mobile phones, and where the mobile phone carrier or one of its partners operates the social network shopping cart 110. An important element of the invention is provision of a social network shopping cart 110 whereby members of a human network can incorporate product information from merchants 100 into their published user-generated content 123 in order to promote the sale of those products, and the fact that the consumers (125a through 125n) of the published UGC can view product promotions and product information as an integral part of the user-generated content, and they can purchase products or mark them for later review and possible purchase, entirely within the published UGC 123 via the consuming component (135a through 135n). Only when finished and ready to check out does the consuming user (now a Buyer) (125a through 125n) interact with the social network shopping cart 111, specifically by going through the shopping cart's checkout procedure. FIG. 2 outlines a method of the present invention. Preliminarily (201), businesses add products available for promotion and sale via the social network 110 to the social network shopping cart 111. Merchants can specify terms under which the products can be promoted and sold when adding them to the shopping cart. Clearly one of the key terms is price, which can be expressed as a fixed price or as a range of prices. In an embodiment of the invention, products can be placed in the social network shopping cart 111 for auction within the social network, and members of the social network could add that product to their UGC and thereby accept bids; the winning bid would get the product, and the creator of the UGC from which the winning bid was entered would receive a reward from the social network shopping cart operator. Business may also upload additional information about their products into the social network shopping cart, for example the dates when the product is available, product images, shipping costs and schedules, promotional materials in text, image or video form, and so forth. In an embodiment of the invention, merchants may specify demographic or other information about the target market of the product, although it should be clear that among the key benefits of the instant invention is the fact that it is the users who self-select by choosing what products to promote and with what people to associate; merchants implicitly are marketing to the people who associate with (network with) the people who choose their products to promote within their UGC. By making demographic and other information about who might find the product most useful, merchants are not so much targeting a market segment as they are advising those who self-select the market segment.

In step 202, social network members create user-generated content for posting or publishing as published UGC 123. As mentioned above, this step could comprise many possible actions by members of the social network, including but not limited to posting a blog entry, creating a video, adding content to a personal web page, updating a personal profile page, or adding a comment or essay in a public forum section of the social network. The social network member then selects products from the social network shopping cart and adds them to her user-generated content posting 203. The user actually inserts a block of code downloaded from the social network shopping cart 111 into her user-generated content; this code block could for example be hypertext markup language (HTML), extensible markup language (XML) or the like. The code could contain a link to an image or a video, such that when a viewer of the UGC clicks on the link they can view the image of watch the video. Such techniques are well-established in the art. The code also contains means for executing a purchase or for marking an item for later review and purchase. These means could be, but are not limited to, a “Buy” button viewable by the user (“user” herein refers to the consumer (125a through 125n) of user-generated content), a “hot spot” in an image or a video which, when moused over, displays a “buy this item” tag, or other similar means.

After the creating user has created her content and added products from the social network shopping cart 111, other social network members view the newly published posting 204 and may optionally choose to view or buy products that are promoted in the new posting. In particular, in step 205 some social network members buy products directly from the posting member's user-generated content posting. The user may choose to continue viewing UGC of the same user, or indeed may move on to other network members' user-generated content. This is an important advantage of the present invention: users may continue browsing the same or other users' UGC as desired, and thereby they may accumulate several purchase decisions (or tentative decisions) before deciding to check out and complete purchases. Users can move to checkout at any time, or they may prompted, if they elect to leave the social network, to go to checkout. Optionally, a social network member's product selections may be kept on hold and revisited on a subsequent visit to the social network; this functionality is implicit in the social network shopping cart, which receives (through the mechanism of the embedded code) a notification each time a user selects a product for viewing or purchase and can store this information for use when the user returns. When a user ultimately does decide to purchase, they proceed to the social network shopping cart checkout 206, where they can choose to add or drop products, add or change method of payment, select shipping options, and so forth. Note, however, that in embodiments where the social network is not online, but is a network of humans conducting offline interactions, the checkout feature will still be present. As is discussed below, there will be a communications means of some sort, typically internet protocol (IP) based, between the user-generated content and the social network shopping cart, and this communications means would be used as well for checkout.

One a purchase has been made, the merchant (or merchants; a single checkout can be conducted to purchase products from a plurality of merchants, and indeed from a plurality of UGC promotions) receives notification of the order and payment arrangements from the service provider 110 that operates the social network shopping cart 207 (recall that this service provider could in fact be the operator of the social network as well, but need not be). Finally, the member from whose UGC each purchase decision was made receives an endorsement fee or other monetary reward from the service provider 110 in step 208. Again, from a single “browsing expedition” or web session, multiple purchases from multiple UGC promotions could be made, and the products could be from multiple merchants. Accordingly, each transaction is tracked in the social network shopping cart as a tuple containing at least the buyer's identity, the content creator's identity, and the product's identity (which can be tied to the merchant based on the data provided in step 201).

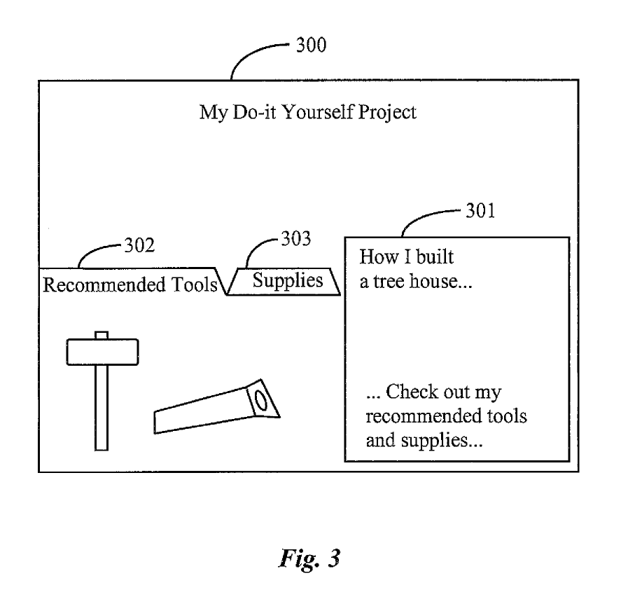

FIG. 3 provides an example of what user-generated content (UGC) containing product promotions according to the invention might look like. In this embodiment, the UGC is a web page 300 containing user-created text 301. In this case the text describes how a DIY (Do it yourself) project was completed; this might be a common type of posting on a homeowner's social network. Additionally, the creator to the page added two tabs labeled “Recommended Tools” 302 and “Supplies” 303. On these tabs are placed either text, tabular data, or (as in the example) images of products that were found useful to the author. It is clear that this is one natural form of mixing user-generated content with product placements (i.e., advertisements). Others who want to replicate the success this author achieved may well want to know what particular tools and supplies were found the most useful, and it would be convenient for such users to be able to click on the items he does not already possess and have them effortlessly shipped to his home in time to start the project on the weekend.

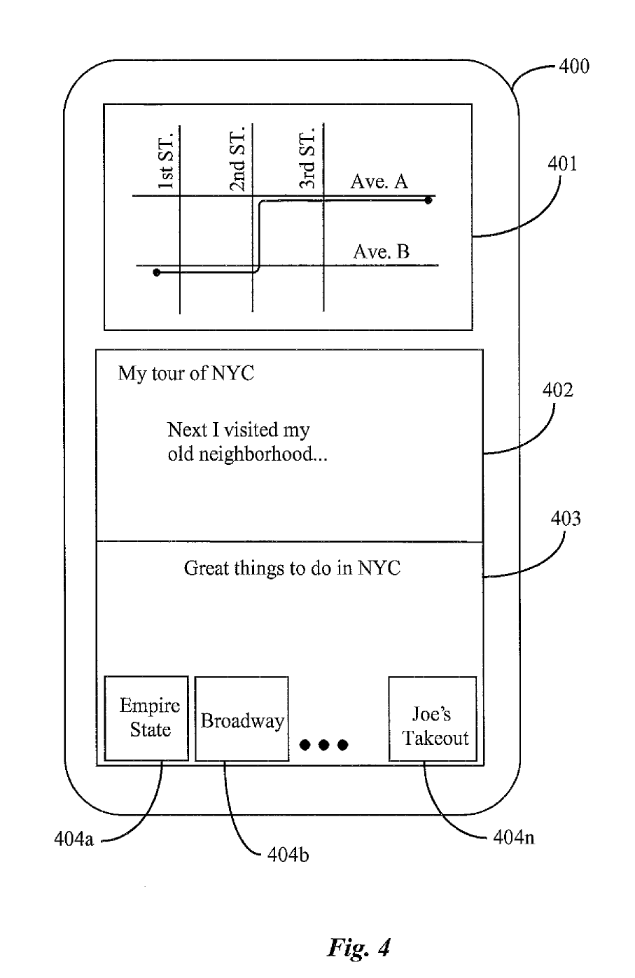

FIG. 4 provides an example of another embodiment of the invention. In this embodiment, user-generated content is viewed on a mobile phone or personal digital assistant (PDA) 400. A member of a social network has created her own content comprising a guided tour of New York City, including a map of the tour as she conducted it 401, a narrative of the tour 402, and a selection of “Great things to do in New York” 403. The items (404a through 404n) are product placements selected by the content creator to enhance the value of her guided tour content by allowing viewers, as they follow her path through the city, to select and purchase additional activities without having to leave her content. Note also that the content creator could leverage the fact that many PDAs and mobile phones today have Global Positioning System (GPS) receivers and can track where the user is in the city very accurately. This can be used to move the map as the user walks the tour, but it can also be used to change the promotions offered 403 based on where the user is. Such location-based product promotions within UGC are an extremely potent form of UGC-based advertising. While location-based services are emerging rapidly in the marketplace, and in particular while leveraging location information in mobile applications is known in the art, it is the combination of this capability with the unique embedding of product promotions within user-generated content (the object of the present invention) that really adds value here. Each item (404a through 404n) represents a recommendation of a product (or service—these terms should be understood to be interchangeable throughout this specification) by a person whom the user is likely to trust more than a mass advertiser because the user is a member of the same social network as the content creator. Thus this location-based advertising example represents an extraordinarily precise targeting of an advertisement, and is thus one for which advertisers will in general be willing to pay a premium.

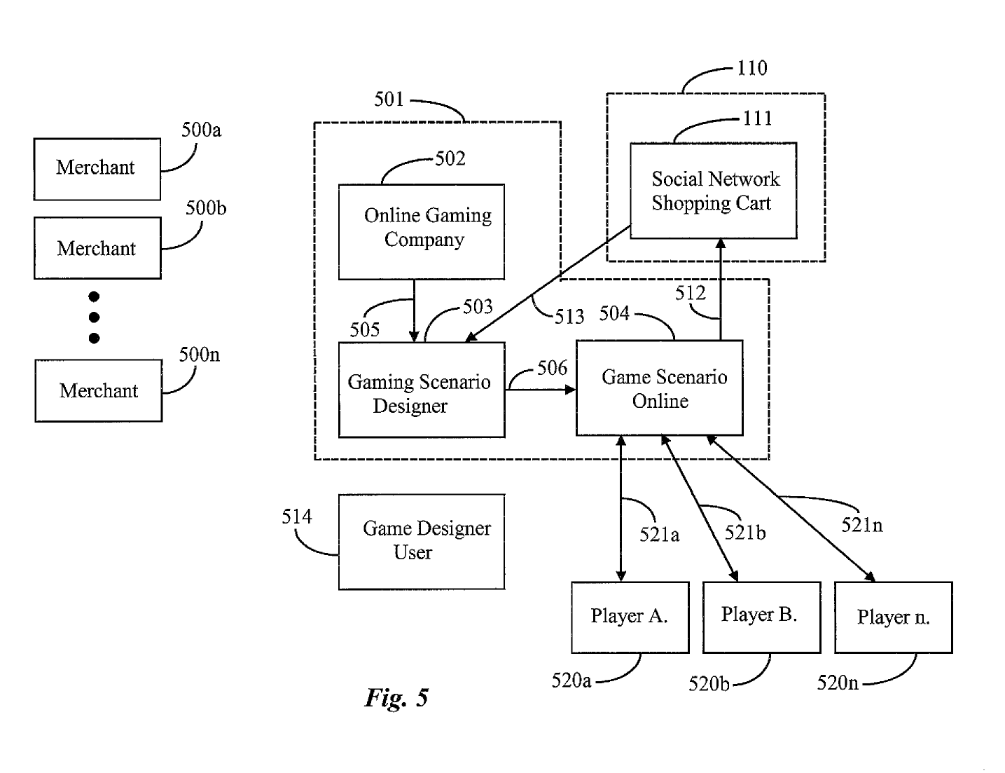

FIG. 5 is yet another embodiment illustrating an exemplary use of the invention to monetize user-generated content. Merchants (500a through 500n) make products available, as before, for promotion by members of a social network via a social network shopping cart 111. In this case, the social network is an online gaming community (514 and 520a through 520n) which share an interest in games produced by game company 502, specifically the game domain 501. Optionally, the merchants could contract with the gaming company 502 to promote their products in the game domain 501, or they could upload product information directly to the social network shopping cart 111 as before. The gaming company provides a game scenario editor 503 tailored to the game domain 501, through the use of which game designer users 514 can design custom scenarios that can be deployed 506 and then viewed online 504 by players (520a through 520n). The game designer user 514 can be a player as well, or she could be a specialist member of the social network who designs high-end scenarios full-time. But as in other embodiments of the invention, by gaining the ability to embed product promotions from merchants 500 into her scenarios, the game designer user 514 gains access to a valuable new revenue stream and a means of enhancing game play. One of the benefits the inventors foresee for this monetization of user-generated content is illustrated in this last comment—when advertisements are inserted by trusted members of the social network in order to enhance the experience of using the social network, they are likely to be viewed as a positive force rather than a burdensome force (which is how people generally view advertising). People are consumers by nature, and they appreciate being informed, so when the information comes in a venue they enjoy, from sources they trust, buyers are likely to appreciate sellers for doing them a service. This upending of the traditional view of the role of advertisers as mass manipulators is important. The product promotions placed within their user-generated content by members of a social network are likely to not be viewed as advertisements at all by their viewers, but rather as welcome sources of information and hassle-free purchasing. To make this point clear, in this example the products being sold might be game accessories, books, and items that are closely tied to the thematic content of the game, and these are items that players of the game would enjoy seeing in the game; real-world consumption becomes part of the alternate reality (especially when one considers virtual worlds, a specialized kind of massively multiplayer online role-playing game that could have promotions added in as shown in FIG. 5).

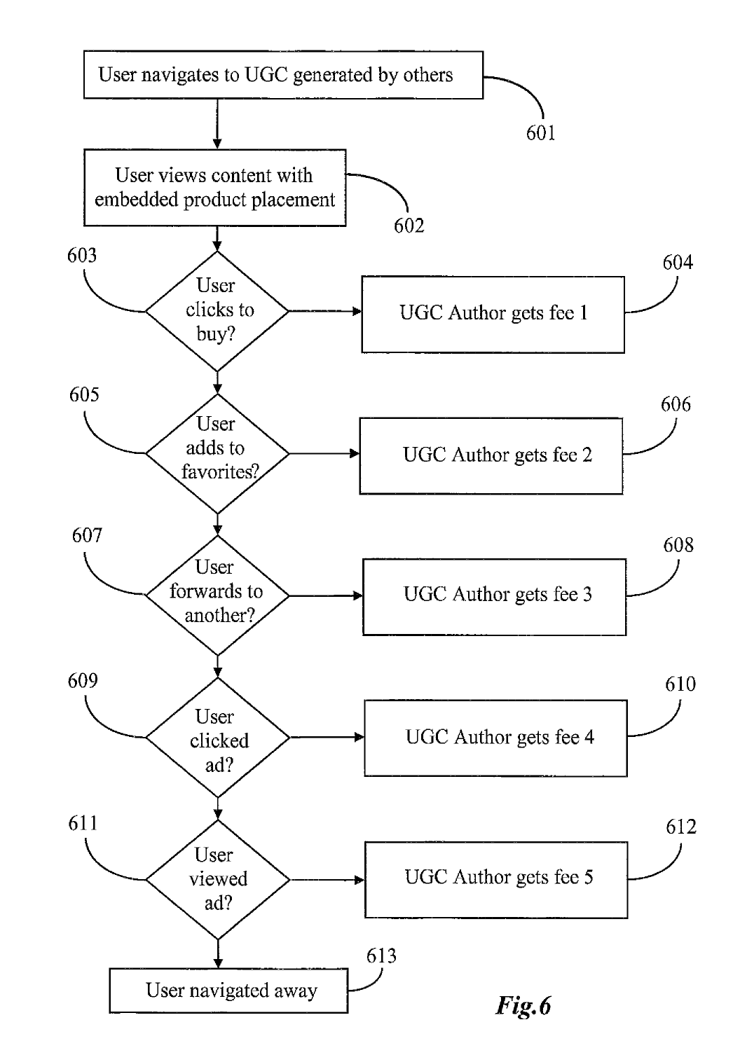

FIG. 6 shows an example of how use of product placements in user-generated content can result in monetization of that content for its creators and for the operator of the social network 120. After a user (125a through 125n) navigates 601 to user-generated content created by other users, and selects a page or view that contains product placement text, images or videos 602, then a series of questions can be continuously evaluated until such time as the user leaves the site entirely 613 (although, as noted above, if a user returns later and buys a previously viewed product, the revenue will clearly be augmented). If a user clicks to buy a product 603, then the UGC author would be entitled to some set fee, called Fee 1 604. Typically, this Fee 1 would be variable based on the value of the product sold, although it does not need to be. Other formats might include fixed fee (for items of generally low cost), fees variable based on purchase type (auction, buy now, discounts, etc could alter the fee), or fees based on the level of sales achieved by the creating user for the month, or quarter. It should be appreciated that there are any number of ways one might choose to calculate the fee; what is essential here is that the user (and the social network site/operator, out of whose fee the creating users' fees are paid in most cases, although again this can be done in several ways according to the invention) gets a monetary reward for selling the product. Similarly, if the user adds an item to his Favorites 605, or otherwise marks it for future reference, a different, generally lower, Fee 2 606 may be paid optionally to the content creator. Similarly, if a user forwards the product to another member of the social network 607, the creator of the UGC where the product was viewed can optionally be paid a Fee 3 608 by the social network operator. In similar fashion, in an exemplary embodiment, when users click on the product placement to view details 609, or when a user simply views the product placement 611, the creator of the content may optionally be paid Fee 4 610 or Fee 5 612, respectively. It should be understood that these fees are exemplary in nature, and some, none or all of them may in fact be paid, and others not listed could be paid, in order to provide the content creator with an incentive to promote products that are likely to be attractive to the members of the social network who are likely to view her content.

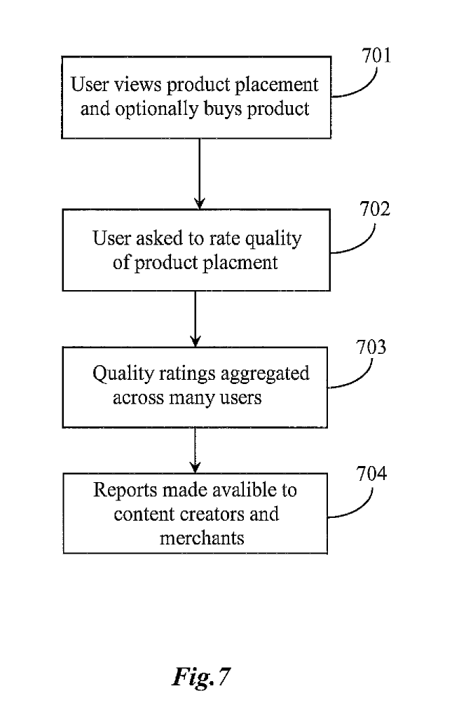

FIG. 7 shows a product placement quality rating process of an embodiment of the invention. It would be extremely useful for a content creator to know which promotions were the most successful, and further to understand whether lack of success is due to lack of interest in the product or, more seriously, due to user discontent with how products are being promoted. Similarly, merchants and optionally the social network operator have a need to understand how effective their marketing activities into the social network are. Merchants may choose to pay more, or to limit availability of certain products for placement to content creators who achieve quality ratings above some minimum threshold. Accordingly, after users view product placements within user-generated content and optionally make purchase decisions 701, users may optionally be asked to rate the perceived quality of the product placement or placements they just viewed 702. The request to rate quality can be done after every click-through, on a random sample basis, after every purchase, or based on any of a number of sampling techniques well-established in the art. The quality ratings provide by users are then aggregated 703 and used to establish overall ratings for each content creator. Ratings can be based on several optional “dimensions”, such as suitability of the product for the target audience, accuracy of the description provided by the content creator (if any), quality of the product and the purchase, payment and shipping processes, and so forth. Essentially any factor that contributes to perceived quality, or the lack thereof, of the product placement, viewing, order and receipt process, and of the products themselves, can be rated in this way. The ratings can then optionally be provided 704 to merchants and content creators. A content creator might use these reports to refine the method of presenting product promotions, or to refine the product selections. Merchants can use this data, as mentioned, to refine their marketing efforts through social networks. Also, optionally feedback scores can be provided to viewers of UGC in the social network, for example by displaying information such as “this member's quality score is 97%, with 32 responses” when a product placement is selected for detailed viewing. This “reputation system” is similar to others known in the art, for example on large auction and ecommerce sites; the additional element here is not so much how the data is gathered or used but more what the data is—it reflects the evolving reputations of members of the social network as recommenders of products. It is anticipated by the inventors that merchants may well be willing to pay more for promotion of their products by content creators who in effect develop reputations as “product gurus to be trusted” among their network membership.

All of the embodiments outlined in this disclosure are exemplary in nature and should not be construed as limitations of the invention.

What is claimed is:

1. An e-commerce system, comprising:
a shopping cart executing on a network-connected server;
product information available at the shopping cart; and
interface software executing on the server for interacting with user-generated content associated with a first user;
wherein the interface software provides product information and code related to a specific product to the user-generated content, the code compatible with the user-generated content, and upon the code being activated in the user-generated content by a second user, the second user is connected to the shopping cart at the server, and is thereby enabled to buy the product.

2. The system of claim 1 wherein the shopping cart executes on a social networking server.

3. The system of claim 1 wherein the shopping cart executes on an online gaming server.

4. The system of claim 1 wherein the shopping cart executes on an online virtual world server.

5. The system of claim 1 wherein the user-generated content is accessed from a web browser.

6. The system of claim 1 wherein the user-generated content is accessed from one of an Internet-connected mobile communications device, a computing device, or a gaming console.

7. The system of claim 1 wherein the product information pertains to products from a plurality of distinct selling entities.

8. The system of claim 1 wherein the shopping cart calculates all costs associated with purchasing the product within the user-generated content and provides an updated total to the second user to facilitate purchase.

9. The system in claim 8 wherein the costs include a fee to be paid to the first user when a specific interaction with the second user occurs.

10. The system of claim 1 wherein the shopping cart, on request from the first user, provides information about a plurality of products available for sale by the first user in content generated by the first user, and upon selection by the first user of a particular product to promote provides to the first user code and product information suitable for embedding in the user-generated content.

11. The system of claim 1 wherein feedback from the second user is collected by the shopping cart and aggregated with similar feedback from a plurality of other users to generate statistics on the quality of product promotions included within user-generated content.

12. The system of claim 9 wherein the fee paid to the first user based is determined at least in part by the quality statistics pertaining to first user.

13. A method for e-commerce, comprising the steps of:
(a) transmitting product information and code related to a specific product by a network-connected server to user-generated content generated by a first user;
(b) embedding the code into the user-generated content for selling the product; and
(c) upon the code being activated in the user-generated content by a second user, connecting the second user to a shopping cart at the server, thereby enabling the second user to purchase the product.

14. The method of claim 13 wherein the shopping cart executes on a social networking server.

15. The method of claim 13 wherein the shopping cart executes on an online gaming server.

16. The method of claim 13 wherein the shopping cart executes on an online virtual world server.

17. The method of claim 13 wherein the user-generated content is accessed from a web browser.

18. The method of claim 13 wherein the user-generated content is accessed from one of an Internet-connected mobile communications device, a computing device, or a gaming console.

19. The method of claim 13 wherein the product information pertains to products from a plurality of distinct selling entities.

20. The method of claim 13 comprising the further step of calculating all costs associated with purchasing the product within the user-generated content and providing an updated total to the second user to facilitate purchase.

21. The method in claim 20 wherein the costs include a fee to be paid to the first user when a specific interaction with the second user occurs.

22. The method of claim 13 wherein the shopping cart further, on request from the first user, provides information about a plurality of products available for sale by the first user in content generated by the first user, and upon selection by the first user of a particular product to promote provides to the first user code and product information suitable for embedding in the user-generated content.

23. The method of claim 13 comprising the further step of collecting feedback from the second user and aggregating with similar feedback from a plurality of other users to generate statistics on the quality of product promotions included within user-generated content.

24. The method of claim 21 wherein the fee paid to the first user based is determined at least in part by the quality statistics pertaining to first user.
